(19) United States
(12) Patent Application Publication
(10) Pub. No.: US 2008/0263584 A1
(43) Pub. Date: Oct. 23, 2008

(54) Advertising Communications Interface

(75) Inventors: Juha Salo, Littoinen (FI); Ahti Muhonen, Hirvihaara (FI); Matthew Snyder, Vancouver (CA)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Nokia Corporation, Espoo (FI)

(21) Appl. No.: 11/738,728

(22) Filed: Apr. 23, 2007

(51) Int. Cl. H04N 7/025

(52) U.S. Cl. 725/32

(57) ABSTRACT

Provided is an apparatus for initiating a bidirectional communications channel via an advertising interface. The apparatus includes a communications unit configured to send and receive data and a processing unit in communication with the communications unit. The processing unit is configured to cause advertising data to be transmitted to a communications device for output as a selectable advertising interface. The advertising data may include contact data for contacting an entity associated with the advertising data, such as an entity associated with content of the advertising data. The contact data may be configured such that selection of the advertising interface at the communications device automatically prompts initiation of a bidirectional communications channel between the communications device and the entity. Methods and computer program products for initiating a bidirectional communications channel via an advertising interface are also provided.

### FIELD OF THE INVENTION

Embodiments of the present invention relate generally to apparatuses, methods, and computer program products for initiating bidirectional communications, and, more particularly, to apparatuses, methods, and computer program products for initiating bidirectional communications via an advertising interface.

### BACKGROUND INFORMATION

Modern communications systems and media are often utilized to provide advertisement information. For example, advertising information is commonly disseminated via newspaper advertisements, via targeted or mass mailings, via television commercials, via electronic mail (“email”), and/or via advertisement banners/windows on a computer display. Such advertisements can be beneficial, providing information regarding, amongst other things, product names and descriptions, price information, and information related to contacting a seller of a product and thereby aiding in determinations as to whether and where to purchase a product.

One limitation often associated with the above described advertisements is that the amount of information that may be feasibly communicated by the advertisement is limited. Whether due to spatial constraints (e.g., as in a newspaper advertisement), time constraints (e.g., as in the length of a television commercial), or some other factor, often only a small portion of the total amount of available product/service information is typically presented in an advertisement. As such, a potential consumer who is confronted with an advertisement and becomes interested in the associated product or service may be required to undertake some amount or research regarding further product/service information. This may involve considerable time and effort on the part of the consumer. Further, depending on the manner in which this information is obtained, the information may not be sufficiently tailored to the needs of the specific consumer at issue (for example, in consulting an Internet-based review of a product).

### BRIEF SUMMARY OF THE INVENTION

In light of the foregoing background, provided are improved apparatuses, methods, and computer program products for initiating bidirectional communications via an advertising interface. By utilizing the advertising interface to initiate bidirectional communications, embodiments may allow for efficiently obtaining information regarding advertised products or services.

In one aspect, an apparatus is provided that includes a communications unit configured to send and receive data and a processing unit in communication with the communications unit. The processing unit is configured to cause advertising data to be transmitted to a communications device for output as a selectable advertising interface. The advertising data may include contact data for contacting an entity associated with the advertising data, such as an entity associated with content of the advertising data. The contact data may be configured such that selection of the advertising interface at the communications device automatically prompts initiation of a bidirectional communications channel between the communications device and the entity. In some cases, the bidirectional communications channel may be established by the processing unit, and may at least partially be established between the apparatus and the communications device.

In one embodiment, the advertising interface may be a graphical advertising interface, selection of which at the communications device may prompt initiation of bidirectional textual communications between the communications device and the entity. The processing unit may be configured to cause at least some of the bidirectional textual communications to be displayed within the graphical advertising interface, perhaps simultaneously with at least some of the advertising data. In another embodiment, the communications unit may include communications means for sending and receiving data, and the processing unit may include processing means for causing advertising data to be transmitted to the communications device for output as a selectable advertising interface.

In another aspect, a method is provided that includes transmitting advertising data to a communications device for output as a selectable advertising interface. The advertising data may include contact data for contacting an entity associated with the advertising data. The contact data may be configured such that selection of the advertising interface at the communications device automatically prompts initiation of a bidirectional communications channel between the communications device and the entity associated with the advertising data. Indication of selection of the advertising interface may be received from the communications device, and initiation of a bidirectional communications channel between the communications device and the entity may be automatically prompted in response to receiving indication of selection of the advertising interface.

In yet another aspect, a computer program product is provided that includes a computer-readable storage medium having computer-readable program code portions stored therein. The computer-readable program code portions include a first executable code portion for transmitting advertising data to a communications device for output as a selectable advertising interface. The advertising data may include contact data for contacting an entity associated with the advertising data. The contact data may be configured such that selection of the advertising interface at the communications device automatically prompts initiation of a bidirectional communications channel between the communications device and the entity associated with the advertising data.

In still another aspect, an apparatus is provided that includes a communications unit configured to send and receive data, the data including advertising data for output via an output device of said apparatus as a selectable advertising interface. The advertising data may include contact data for contacting an entity associated with the advertising data. The apparatus also includes a processing unit in communication with the communications unit. The processing unit is configured to automatically initiate a bidirectional communications channel with the entity in response to selection of the advertising interface via a user input device of the apparatus.

In a further aspect, a computer program product is provided that includes a computer-readable storage medium having computer-readable program code portions stored therein. The computer-readable program code portions include a first executable code portion for receiving advertising data including contact data for contacting an entity associated with the advertising data. The computer-readable program code portions also include a second executable code portion for outputting the advertising data as a selectable advertising interface. A third executable code portion is provided for selecting the advertising interface, and a fourth executable code portion is provided for automatically initiating a bidirectional communications channel with the entity in response to selecting the advertising interface.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is schematic view of a communications system configured in accordance with an exemplary embodiment;

FIG. 2 is a block diagram of the communications system of FIG. 1;

FIG. 3 is a block diagram representing an exemplary method of operation of a communications system configured in accordance with an exemplary embodiment;

FIG. 4 is a flow chart representing an exemplary method of operation of the communications system of FIG. 3;

FIG. 5 is a block diagram of a communication system configured in accordance with yet another exemplary embodiment; and

FIGS. 6A-6C are exemplary embodiments of graphical advertising interfaces, each interface embodiment being shown both as initially displayed and as displayed following initiation of a bidirectional textual communications channel.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

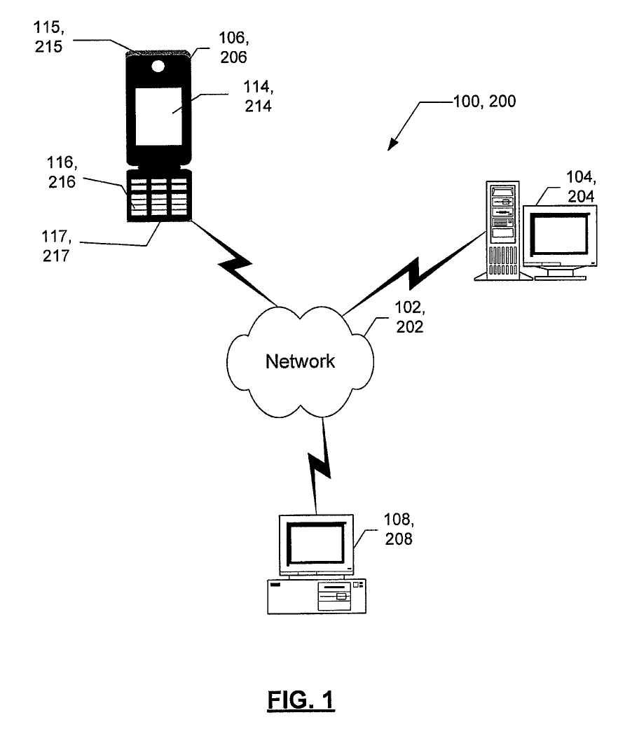

Referring to FIG. 1, therein is schematically shown a communications system 100 configured in accordance with an exemplary embodiment. Communications system 100 includes various devices capable of communicating with one another, for example, via a network 102. Network 102 may be, for example, a personal area network, a local area network, a wide area network, and/or the Internet. The devices communicating via network 102 may include, for example, a server 104 and one or more communications devices, such as a cellular telephone 106, a personal digital assistant or other mobile computing device, and/or a personal computer 108. In some embodiments, server 104 may also be a personal computer.

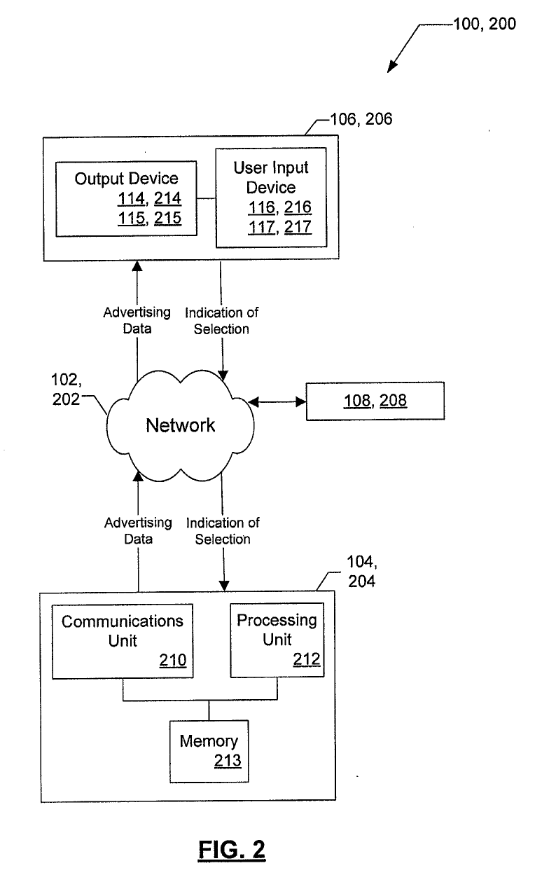

Referring to FIG. 2, therein is shown a block diagram of communications system 100 of FIG. 1 (also labeled 200). Server 204 may include a communications unit 210 configured to send and receive data. For example, communications unit 210 may include communications means, such as a transceiver and/or a network card, and the like. A processing unit 212, including, for example, processing means such as a microprocessor and/or an application specific integrated circuit and the like, may communicate with communications unit 210. Processing unit 212 may be configured to cause advertising data to be transmitted to a communications device, such as to cellular telephone 206 in the illustrated case, for output as a selectable advertising interface (the advertising interface is described further below). The advertising data may be stored in a memory 213 associated with server 204 and retrieved therefrom for transmission to cellular telephone 206, or may be stored and/or transmitted from elsewhere, such as from computer 208, a database, or the like, in response to direction from the processing unit 212. Instructions executable by processing unit 212 in carrying out some or all of the above functions may also be stored in memory 213.

The advertising data includes, amongst other things, data necessary to create the advertising interface. For example, the advertising data will include advertising content, such as, for example, product names, product information, and contact and/or purchasing information. The advertising data may also include data related to the formatting upon output and the intended manner of selection of the advertising interface. This set of data may include, for example, data regarding the visual display of logos, the volume of an audio output, and/or instructions for prompting and receiving an advertising interface selection. However, more specifically, the format and contents of the advertising data may depend on, amongst other factors, the manner in which the data are intended to be outputted.

Output and subsequent selection of the advertising interface may be accomplished in a variety of ways, depending on the design and capabilities of the communications device at issue. For example, where the communications device is a cellular telephone 206 including an output device, such as a display 214 and/or an audio speaker 215, and a user input device, such as a keypad 216, a microphone 217, a pointing device, and/or soft keys, the advertising interface may be outputted via display 214 as a graphical advertising interface, and selections or other input can be provided using keypad 216. Alternatively, the advertising data may be audibly outputted via the speaker 215 and selection indicated by speaking into the microphone 217. Regardless of the chosen method of output, the advertising data could be appropriately formatted to be consistent with the output method chosen as described above. In some embodiments, the advertising data may include or be accompanied by instructions executable, say, by a processing device of the cellular telephone 206 (or whichever communications device receives the advertising data) to direct the display of the advertising interface by the communications device receiving the advertising data, while in other embodiments, the advertising data may be transmitted without instructions for use, to be utilized by cellular telephone 206 already including any necessary hardware and/or software for directing the display of the advertising interface by the communications device receiving the advertising data.

The advertising data may include contact data for contacting an entity associated with the advertising data. The contact data may be included with the advertising data in a variety of ways, such as being incorporated into the advertising data, being appended to the advertising data, being included as part of the metadata associated with the advertising data, or being transmitted generally in conjunction with the advertising data. The entity associated with the advertising data may be, for example, the entity represented by the content of the advertising data. For instance, if the advertising data represents products sold by XYZ Company, XYZ Company (or perhaps a distributor thereof) might be the entity associated with the advertising data, and contact data for XYZ Company may be provided as part of the advertising data. Alternatively, the entity associated with the advertising data could be an entity responsible for the compilation of the data, such as an advertising firm, a network provider, an Internet Technologies specialist, etc. Throughout the specification, the entity associated with advertising data will be referred to as the “advertising entity,” although it should be understood that this entity may or may not be associated with the content of the advertising data, but may only be associated more generally with the advertising data.

The contact data may be configured such that, when the associated advertising interface is outputted at cellular telephone 206 (or whichever communications device is being utilized), selection of the advertising interface (e.g., via pointing device in response to a graphical advertising interface or via a microphone in response to an audible advertising interface, as described earlier) automatically prompts initiation of a bidirectional communications channel between the cellular telephone 206 and the advertising entity. For example, selection of the advertising interface may initiate a voice call or an instant messaging session between the cellular telephone 206 and the voice portal or instant messaging portal, respectively, of a computer 208 operated by the advertising entity. Along these lines, the advertising data may include or be accompanied by instructions executable by a processing device of the cellular telephone 206 for initiating the bidirectional communications channel, or may be utilized by cellular telephone 206 inherently equipped with such functionality.

As used herein, the term “bidirectional communications channel” should be understood to refer to a communications link that allows for the near-simultaneous transfer of data in two directions, with each party to the communication being capable of both requesting and providing information. Simple examples of bidirectional communications channels include the voice channel associated with a voice call and the bidirectional textual communications channel associated with an instant messaging session. The communications facilitated by a bidirectional communications channel may be contrasted by a server-client relationship, in which only one side spontaneously requests information (a server may request, for example, identification or authorization information, but such requests are usually in response to a prior request from a client). The communications facilitated by a bidirectional communications channel may also be contrasted, for example, by communications that occur through the exchange of a series of electronic mail messages, in which involve a series of unidirectional communications channels rather than a bidirectional communications channel.

In some cases, processing unit 212 may be configured to establish, in response to selection of the advertising interface at the communications device, the bidirectional communications channel between the cellular telephone 206 and the advertising entity. For example, server 204 may receive indication of the selection of the advertising interface and may initiate communications with computer 208 of the advertising entity, possibly via the network 202, on behalf of the cellular telephone 206. The ensuing communications channel would be established partially between server 204 and cellular telephone 206 and partially between server 204 and computer 208. In these cases, cellular telephone 206 may simply act as a terminal of server 204. In other cases, cellular telephone 206 and computer 208 may communicate independently of server 204, again possibly via network 202. In still other cases, the bidirectional communications channel could be established directly between server 204 and cellular telephone 206, as in the case where server 204 is operated by the advertising entity.

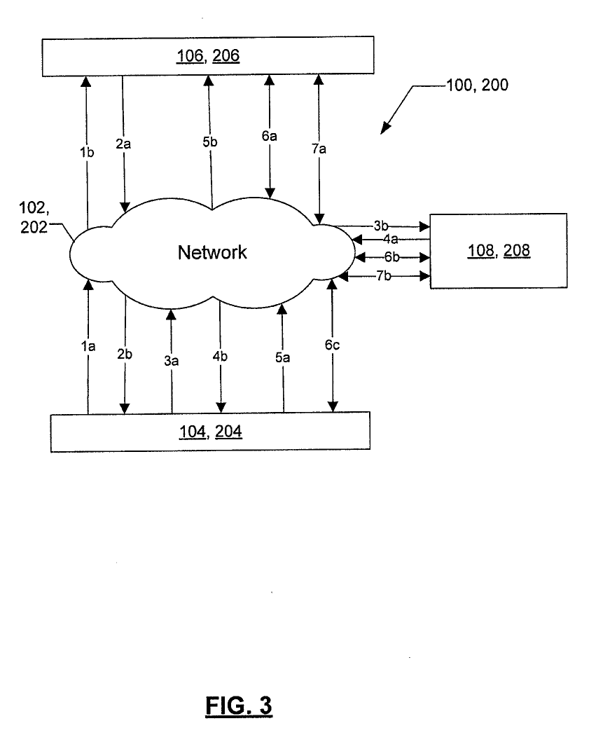

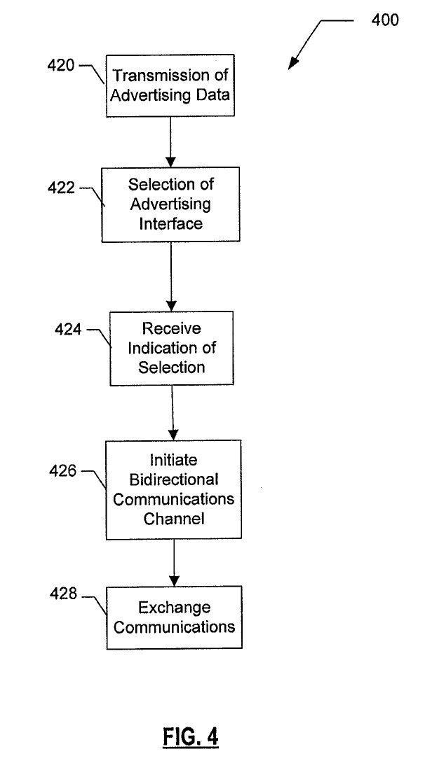

Referring to FIGS. 3 and 4, therein are shown a block diagram and a flow chart, respectively, together representing an exemplary method of operation 400 of a communications system 300 configured in accordance with an exemplary embodiment. Communications system 300 includes a server 304, a first communications device 306, and a second communications device 308 associated with an advertising entity, all of which are capable of communicating via a network 302. The method is demonstrated by assuming an advertising interface consisting of a graphical advertising interface that may be displayed with a display device of first communications device 306, although other types of advertising interfaces are also possible.

Operation begins at Block 420 with the transmission of advertising data (represented by the arrows labeled 1a and 1b of FIG. 3) from server 304 to first communications device 306 for output as a selectable advertising interface, in this case a graphical advertising interface that is outputted via a display of first communications device 306. The advertising data includes contact data (such as an instant messaging address) for contacting the advertising entity. At Block 422, the graphical advertising interface is selected at cellular telephone 306, such as via a user input device. At Block 424, indication of selection of the graphical advertising interface may be received from first communications device 306 (represented by arrows 2a and 2b of FIG. 3).

At Block 426, reception of the indication of selection of the graphical advertising interface may prompt initiation of a bidirectional communications channel, in the present case a bidirectional communications channel supporting bidirectional textual communications. For example, server 304 may contact second communications device 308 regarding a desire by first communications device to initiate bidirectional textual communications (represented by arrows 3a and 3b), may receive a reply indicating a willingness by second communications device 308 to enter into communications (represented by arrows 4a and 4b), and may notify first communications device 306 of such willingness (represented by arrows 5a and 5b). Messages can then be exchanged between cellular telephone 306 and computer 308 at Block 428. The bidirectional textual communications channel may be established in several ways. For example, the channel may be established through server 304, such that communications from cellular telephone 306 to computer 308, and vice versa, are routed via server 304 (represented by arrows 6a, 6b, and 6c of FIG. 3). Alternatively, a communication back and forth between cellular telephone 306 to computer 308 may be independent of server 304 (represented by arrows 7a and 7b of FIG. 3).

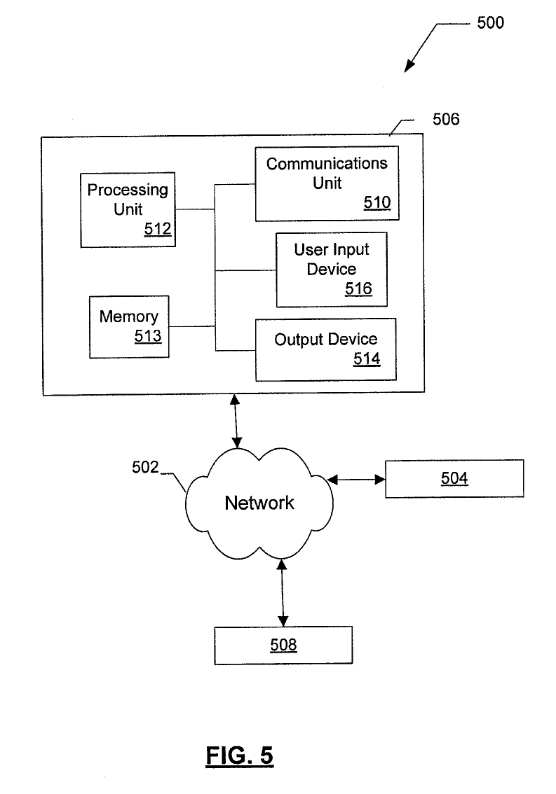

Referring to FIG. 5, therein is shown a block diagram of a communication system 500 configured in accordance with yet another exemplary embodiment. Communications system 500 includes a server 504 and several communications devices, such as a cellular telephone 506 (or other communications device) and a personal computer 508, all of which are capable of communicating with one another via a network 502. Cellular telephone 506 may include a communications unit 510 configured to send and receive data. For example, communications unit 510 may include communications means, such as a transceiver and/or a network card, and the like. A processing unit 512 including, for example, processing means, such as a microprocessor and/or an application specific integrated circuit and the like, may communicate with communications unit 510. Cellular telephone 506 may also include a memory 513 that communicates with communications unit 510 and processing unit 512, as well as an output device 514 and a user input device 516.

Communications unit 510 may receive advertising data that may be output via output device 514 as a selectable advertising interface, for example, as a selectable graphical advertising interface. The advertising data may be received, for example, from server 504, which may be an advertisement server, and may be stored in memory 513. The advertising data may include contact data for contacting an entity associated with the advertising data (i.e., an “advertising entity”). Processing unit 512 may be configured to automatically initiate a bidirectional communications channel, for example, a channel supporting bidirectional textual communications, with the advertising entity in response to selection of the advertising interface via user input device 516. Processing unit 512 may also govern and/or control the output of the selectable advertising interface via output device 514, as well as the process of selecting the interface. Instructions executable by processing unit 512 in carrying out some or all of the above functions may also be stored in memory 513.

As discussed above, a processing unit, either associated with a communications device or located elsewhere (for example, in a server remote from the communications device), may facilitate output of an advertising interface at the communications device and, in some cases, trigger initiation of a bidirectional communications channel in response to selection thereof. In one embodiment, the advertising interface may be a graphical advertising interface, and the communications may be textual communications. Regardless of the location of the processing unit responsible for providing the advertising interface and/or establishing the bidirectional communications channel, the processing unit may cause at least some of the bidirectional textual communications to be displayed within the graphical advertising interface. In some embodiments, the bidirectional textual communications may be displayed within the graphical advertising interface simultaneously with at least some of said advertising data.

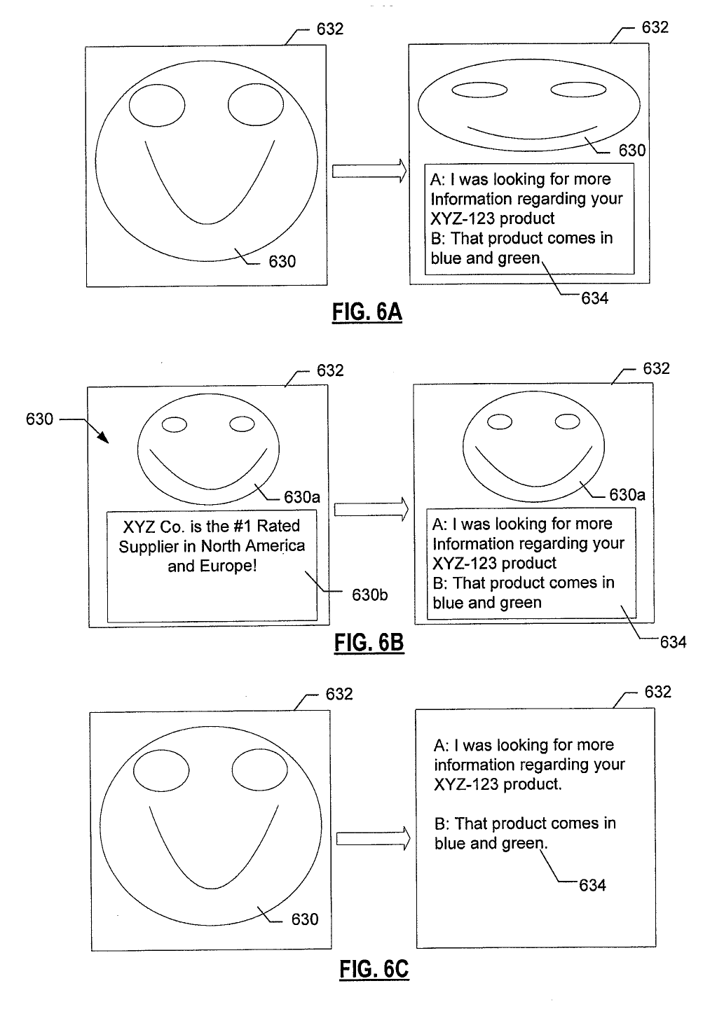

For example, referring to FIGS. 6A-6C, therein are shown exemplary embodiments of graphical advertising interfaces, each interface embodiment being shown both as initially displayed and as displayed following advertising interface selection and the resulting initiation of the bidirectional textual communications channel. As shown in FIG. 6A, advertising data/content 630 (a logo in the illustrated embodiment) may initially occupy virtually the entire graphical advertising interface 632. After initiation of the bidirectional textual communications channel, the advertising content 630 can be reduced in scale along one or more directions to make room within the graphical advertising interface 632 for display of the textual communications 634. Alternatively, as shown in FIG. 6B, advertising content 630 can be designed to have several displayable portions, such as a first portion 630a (here, a logo) and a second portion 630b (here, textual advertising information), which may be designed to allow at least one of the portions to be logically displayed without the other. In this embodiment, both portions 630a, 630b may be initially displayed, and after initiation of the bidirectional textual communications channel, first portion 630a may remain displayed while second portion 630b is replaced with a display of the textual communications. As yet another alternative, shown in FIG. 6C, the entire graphical advertising interface 632 may be initially consumed by advertising data/content 630 (as earlier, a logo), and may be entirely utilized to display textual communications 634 following initiation of the bidirectional textual communications channel.

As described above and as will be appreciated by one skilled in the art, embodiments of the present invention may be configured as a system, an apparatus, or a method. Accordingly, embodiments of the present invention may be comprised of various means including entirely of hardware, entirely of software, or any combination of hardware and software. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a communications unit configured to send and receive data; and
a processing unit in communication with said communications unit and configured to cause advertising data to be transmitted to a communications device for output as a selectable advertising interface, said advertising data including contact data for contacting an entity associated with said advertising data,
wherein said contact data is configured such that selection of the advertising interface at the communications device automatically prompts initiation of a bidirectional communications channel between the communications device and the entity.

2. An apparatus according to claim 1, wherein said processing unit is configured to cause advertising data including contact data to be transmitted to the communications device for output as a selectable graphical advertising interface, and wherein said contact data is configured such that selection of the graphical advertising interface at the communications device prompts initiation of bidirectional textual communications between the communications device and the entity.

3. An apparatus according to claim 2, wherein said processing unit is configured to cause at least some of the bidirectional textual communications to be displayed within the graphical advertising interface.

4. An apparatus according to claim 3, wherein said processing unit is configured to cause at least some of the bidirectional textual communications to be displayed within the graphical advertising interface simultaneously with at least some of said advertising data.

5. An apparatus according to claim 1, wherein said processing unit is configured to cause advertising data that includes contact data for contacting an entity that is associated with a content of said advertising data to be transmitted to the communications device.

6. An apparatus according to claim 1, wherein said processing unit is further configured to establish a bidirectional communications channel between the communications device and the entity associated with said advertising data in response to selection of the advertising interface at the communications device.

7. An apparatus according to claim 6, wherein the communications channel is at least partially established between said apparatus and the communications device.

8. An apparatus according to claim 1, wherein said communications unit includes communications means for sending and receiving data, and wherein said processing unit includes processing means for causing advertising data to be transmitted to a communications device for output as a selectable advertising interface.

9. A method comprising:
transmitting advertising data to a communications device for output as a selectable advertising interface, the advertising data including contact data for contacting an entity associated with the advertising data,,
wherein said contact data is configured such that selection of the advertising interface at the communications device automatically prompts initiation of a bidirectional communications channel between the communications device and the entity associated with the advertising data.

10. A method according to claim 9, further comprising receiving indication of selection of the advertising interface from the communications device and automatically prompting initiation of a bidirectional communications channel between the communications device and the entity in response to receiving indication of selection of the advertising interface.

11. A method according to claim 10, wherein said automatically prompting initiation of a bidirectional communications channel between the communications device and the entity includes establishing a bidirectional communications channel between the communications device and the entity associated with the advertising data.

12. A method according to claim 9, wherein said transmitting advertising data including contact data for contacting an entity associated with the advertising data includes transmitting advertising data including contact data for contacting an entity associated with a content of the advertising data.

13. A method according to claim 9, wherein said transmitting advertising data to the communications device for output as a selectable advertising interface, the advertising data including contact data configured such that selection of the advertising interface at the communications device automatically prompts initiation of the bidirectional communications channel between the communications device and the entity associated with the advertising data, includes transmitting advertising data to the communications device for output as a selectable graphical advertising interface, the advertising data including contact data configured such that selection of the advertising interface at the communications device automatically automatically prompts initiation of bidirectional textual communications.

14. A method according to claim 13, further comprising displaying at least some of the bidirectional textual communications within the graphical advertising interface.

15. A method according to claim 14, wherein said displaying at least some of the bidirectional textual communications within the graphical advertising interface includes displaying at least some of the bidirectional textual communications within the graphical advertising interface simultaneously with at least some of the advertising data.

16. A computer program product comprising a computer-readable storage medium having computer-readable program code portions stored therein, the computer-readable program code portions comprising:
a first executable code portion for transmitting advertising data to a communications device for output as a selectable advertising interface, the advertising data including contact data for contacting an entity associated with the advertising data,
wherein said contact data is configured such that selection of the advertising interface at the communications device automatically prompts initiation of a bidirectional communications channel between the communications device and the entity associated with the advertising data.

17. A computer program product according to claim 16, further comprising a second executable code portion for receiving indication of selection of the advertising interface from the communications device and a third executable code portion for automatically prompting initiation of a bidirectional communications channel between the communications device and the entity in response to receiving indication of selection of the advertising interface.

18. A computer program product according to claim 17, wherein said third executable code portion for automatically prompting initiation of a bidirectional communications channel between the communications device and the entity includes an executable code portion for automatically establishing a bidirectional communications channel between the communications device and the entity associated with the advertising data.

19. A computer program product according to claim 17, wherein said first executable code portion for transmitting advertising data to the communications device for output as a selectable advertising interface, the advertising data including contact data configured such that selection of the advertising interface at the communications device automatically prompts initiation of the bidirectional communications channel between the communications device and the entity associated with the advertising data, includes an executable code portion for transmitting advertising data to the communications device for output as a selectable graphical advertising interface, the advertising data including contact data configured such that selection of the advertising interface at the communications device automatically prompts initiation of bidirectional textual communications.

20. A computer program product according to claim 19, further comprising a second executable code portion for displaying at least some of the bidirectional textual communications within the graphical advertising interface.

21. A computer program product according to claim 20, wherein said second executable code portion for displaying at least some of the bidirectional textual communications within the graphical advertising interface includes an executable code portion for displaying at least some of the bidirectional textual communications within the graphical advertising interface simultaneously with at least some of the advertising data.

22. A computer program product according to claim 16, wherein said first executable code portion for transmitting advertising data including contact data for contacting an entity associated with the advertising data includes an executable code portion for transmitting advertising data including contact data for contacting an entity associated with a content of the advertising data.

23. An apparatus comprising:
a communications unit configured to send and receive data, the data including advertising data for output via an output device of said apparatus as a selectable advertising interface, the advertising data including contact data for contacting an entity associated with the advertising data; and
a processing unit in communication with said communications unit and configured to automatically initiate a bidirectional communications channel with the entity in response to selection of the advertising interface via a user input device of said apparatus.

24. An apparatus according to claim 23, wherein said communications unit is configured to receive advertising data for output via the output device as a selectable graphical advertising interface, and wherein said processing unit is configured to initiate bidirectional textual communications with the entity in response to selection of the graphical advertising interface via the user input device.

25. An apparatus according to claim 24, wherein said processing unit is configured to cause at least some of the bidirectional textual communications to be displayed within the graphical advertising interface.

26. An apparatus according to claim 25, wherein said processing unit is configured to cause at least some of the bidirectional textual communications to be displayed within the graphical advertising interface simultaneously with advertising data.

27. An apparatus according to claim 23, wherein said communications unit is configured to receive advertising data including contact data for contacting an entity associated with a content of the advertising data.

28. An apparatus according to claim 23, wherein said communications unit includes communications means for sending and receiving data, and wherein said processing unit includes processing means for automatically initiating a bidirectional communications channel with the entity in response to selection of the advertising interface via a user input device of said apparatus.

29. A computer program product comprising a computer-readable storage medium having computer-readable program code portions stored therein, the computer-readable program code portions comprising:
a first executable code portion for receiving advertising data including contact data for contacting an entity associated with the advertising data;
a second executable code portion for outputting the advertising data as a selectable advertising interface;
a third executable code portion for selecting the advertising interface; and
a fourth executable code portion for automatically initiating a bidirectional communications channel with the entity in response to selecting the advertising interface.

30. A computer program product according to claim 29, wherein said second executable code portion includes an executable code portion for outputting the advertising data as a selectable graphical advertising interface, and wherein said fourth executable code portion includes an executable code portion for automatically initiating bidirectional textual communications with the entity in response to selecting the graphical advertising interface.

31. A computer program product according to claim 30, further comprising a fifth executable code portion for causing at least some of the bidirectional textual communications to be displayed within the graphical advertising interface.

32. An apparatus according to claim 31, wherein said fifth executable code portion includes an executable code portion for causing at least some of the bidirectional textual communications to be displayed within the graphical advertising interface simultaneously with advertising data.

33. An apparatus according to claim 29, wherein said a first executable code portion for includes an executable code portion for receiving advertising data including contact data for contacting an entity associated with a content of the advertising data.
